(19) United States
(12) Patent Application Publication
(10) Pub. No.: US 2013/0116813 A1
(43) Pub. Date: May 9, 2013

(54) OPERATING AND MONITORING APPARATUS AND METHOD

(71) Applicant: YOKOGAWA ELECTRIC CORPORATION, Tokyo (JP)

(72) Inventors: Shinichi Nagai, Yokohama-shi (JP); Yasunori Kobayashi, Musashino-shi (JP)

(73) Assignee: YOKOGAWA ELECTRIC CORPORATION, Tokyo (JP)

(21) Appl. No.: 13/673,415

(22) Filed: Nov. 9, 2012

(30) Foreign Application Priority Data
Nov. 9, 2011 (JP) 2011-245545

(51) Int. Cl. G06F 19/00

(52) U.S. Cl. 700/108

(57) ABSTRACT

An operating and monitoring apparatus for monitoring an operating condition of a plant through a monitoring screen of the present disclosure. The apparatus includes a storage unit which stores a plurality of display screens to be displayed on the monitoring screen; a receipt unit which receives an operation of selecting one display screen among the display screens stored in the storage unit; and a display unit which displays the display screen, selected through the receipt unit, on the monitoring screen. The display screens stored in the storage unit includes, for example, five to nine display elements, and the display elements are, for example, graphs or patterns associated with numerical values based on data acquired from the plant.

### BACKGROUND OF THE INVENTION

The present disclosure relates to an operating and monitoringoperating and monitoring apparatus and an operating and monitoringoperating and monitoring method, which monitor operating condition of a plant through a monitoring screen.

In the case of a large plant, when an operating condition of the plant is monitored by an operating and monitoringoperating and monitoring screen, it is difficult to display all internal devices of the plant on a single screen. For this reason, a part of a process flow is displayed on a split screen along the process flow. In this case, typically, a split display screen is created based on an idea that displays operating condition of a range as wide as possible on a split display screen showing a part of a process flow. On the split display screen, detailed information about a part of a plant, operating conditions, and an arrow indicating a relation with other screen are displayed in a full screen. Information displayed on the screen includes, for example, the following information. (1) Process flow, (2) Measurement point (tag name) of process data such as flow rate and temperature, and a current value thereof, (3) Operational status of a pump, and (4) Abnormal value warning (alarm). Also, as the information displayed on the split display screen, digitized numerical information from a Distributed Control System (DCS) is widely used.

In many cases, the split display screen is automatically created without thorough analysis. Typically, the displayed information is not prioritized. An operator prepares variables, which are thought as important by the operator, for example, a trend graph including a plurality of tags. The operator performs an operation while referring to these variables.

On the other hand, an attempt has recently been made to configure a screen of an HMI (Human Machine Interface: operating and monitoringoperating and monitoring terminal) as follows. That is, on this screen, an entire plant an operator covers is stratified in three levels (e.g., level 1: entire plant, level 2: operating unit, level 3: detailed setting), depending on level of detail. On the level-3 screen, for example, all the instruments are displayed. Using the screen, the operator can acquire detailed information including digital values. In addition, the operator can change a variety of detailed settings. On the level-2 screen, mainly, for example, a variety formats of information necessary for operation and a plurality of key monitoring information are integrated. Mainly, the operator is expected to utilize this level of information for normal operations. On the level-1 screen, for example, only information related to the entire plant is displayed. This screen is used for overview of the entirety. An operating and monitoringoperating and monitoring apparatus disclosed in Japanese Patent Application Laid-Open No. 2011-154423 has a graphical user interface function of providing an operating and monitoring screen for operating and monitoring a plant.

### SUMMARY

An operating and monitoring apparatus for monitoring operating condition of a plant through a monitoring screen of the present disclosure includes, for example, a storage unit which stores a plurality of display screens to be displayed on the monitoring screen; a receipt unit which receives an order of selecting one particular display screen among the display screens stored in the storage unit; and a display unit which displays the display screen, selected through the receipt unit, on the monitoring screen, wherein the every display screen stored in the storage unit includes five to nine display elements, and the display elements are analog graphs or patterns associated with numerical values based on data acquired from the plant.

### BRIEF DESCRIPTION OF DRAWINGS

FIG. 1 is a block diagram illustrating a configuration of a field control system to which an operating and monitoring station is applied as an operating and monitoring apparatus according to an embodiment;

FIG. 2 is a diagram illustrating a display example of a display screen in a monitoring screen of an operating and monitoring station;

FIG. 3 is a diagram illustrating an example of a map which is displayed by a display unit;

FIG. 4A is a diagram illustrating a correspondence relation between each split screen and a display element;

FIG. 4B is a diagram illustrating a display element associated with a split screen “L2-3”; and

FIG. 4C is a diagram illustrating a display element associated with a split screen “L2-2”.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In a task of monitoring an operation of a plant, disturbances are generated in various places. Therefore, it is preferable to use a screen covering a process of a range as wide as possible. However, as a covering area expands, an amount of information included on the screen also increases. When an enormous amount of information is collectively displayed on a single screen, it is difficult to extract important information from the enormous amount of information, for example, an event in which a status is changing. Therefore, an operator finds a problem, while referring to various screens. For this reason, it is likely that a mental and/or physical stress the operator receives will be increased, and thus, the productivity of the operator will be decreased.

There is a limitation to the number of events that can be recognized at a time by a human and can be processed in parallel. By utilizing techniques such as information chunking, a limitation to information to be displayed on a single screen has been attempted to be relaxed. However, in the present circumstances, there is no specific guidance on to what extent the amount of information to be displayed on a single screen is limited.

An object of the present disclosure is to provide an operating and monitoring apparatus and an operating and monitoring method, which can suppress an operator's confusion and a dilution of an operator's consciousness due to excessive information.

An operating and monitoring apparatus for monitoring operating condition of a plant through a monitoring screen of the present disclosure includes: a storage unit which stores a plurality of display screens to be displayed on the monitoring screen; a receipt unit which receives an operation of selecting one display screen among the display screens stored in the storage unit; and a display unit which displays the display screen, selected through the receipt unit, on the monitoring screen, wherein the display screens stored in the storage unit includes five to nine display elements, and the display elements are graphs or patterns associated with numerical values based on data acquired from the plant.

According to the operating and monitoring apparatus, the number of the display elements to be displayed on the display screen is limited to a range of 5 to 9. Therefore, it is possible to suppress the operator's confusion and the dilution of the operator's consciousness due to excessive information.

The display screen may be a split display screen which displays a part of the plant.

The operating and monitoring apparatus of the present disclosure may further include a calculation unit which calculates the numerical values based on the data acquired from the plant, and the calculation result of the calculation unit may be frequently reflected to the display element which is displayed by the display unit.

The display unit may display a map in which the display element is associated with a display area, and represent the display area, which is associated with the display element included in the display screen displayed on the monitoring screen, on the map.

An operating and monitoring method for monitoring operating condition of a plant through a monitoring screen includes: a storing step of storing a plurality of display screens to be displayed on the monitoring screen; a receiving step of receiving an operation of selecting one display screen among the display screens stored in the storing step; and a displaying step of displaying the display screen, selected through the receiving step, on the monitoring screen, wherein the display screens stored in the storing step includes five to nine display elements, and the display elements are graphs or patterns associated with numerical values based on data acquired from the plant.

According to the operating and monitoring method, the number of the display elements to be displayed on the display screen is limited to a range of 5 to 9. Therefore, it is possible to suppress the operator's confusion and the dilution of the operator's consciousness due to excessive information.

The display screen may be a split display screen which displays a part of the plant.

According to the operating and monitoring apparatus of the present disclosure, the number of the display elements to be displayed on the display screen is limited to a range of 5 to 9. Therefore, it is possible to suppress the operator's confusion and the dilution of the operator's consciousness due to excessive information.

According to the operating and monitoring method of the present disclosure, the number of the display elements to be displayed on the display screen is limited to a range of 5 to 9. Therefore, it is possible to suppress the operator's confusion and the dilution of the operator's consciousness due to excessive information.

Hereinafter, an operating and monitoring apparatus according to an embodiment of the present disclosure will be described.

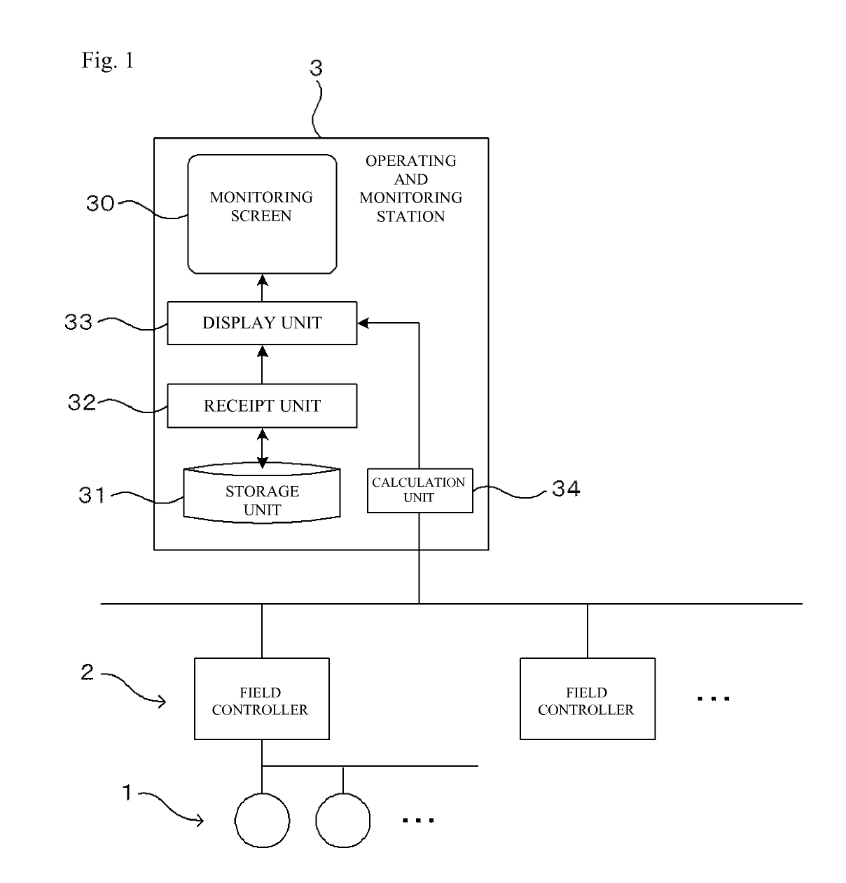

FIG. 1 is a block diagram illustrating a configuration of a field control system to which an operating and monitoring station is applied as the operating and monitoring apparatus according to the present embodiment.

As illustrated in FIG. 1, the field control system includes a plurality of field devices 1, a plurality of field controllers 2, and an operating and monitoring apparatus 3. The field devices 1 include a variety of sensors and valves distributed in a plant. The field controllers 2 are connected to the field devices 1. The operating and monitoring apparatus 3 is connected to the controllers 2. The operating and monitoring apparatus 3 operates and monitors the field devices 1 through the field controllers 2. The operating and monitoring apparatus 3 includes a monitoring screen 30 for monitoring the operation of the plant.

As illustrated in FIG. 1, the operating and monitoring station 3 includes a storage unit 31, a receipt unit 32, a display unit 33, and a calculation unit 34. The storage unit 31 stores a plurality of split screens to be displayed on the monitoring screen 30, other display screen, and display information which is to be described later. The receipt unit 32 receives an operation of selecting one screen among the split screens stored in the storage unit 31. The display unit 33 displays the split screen, which is selected through the receipt unit 32, on the monitoring screen 30. The calculation unit 34 calculates a numerical value to be represented by the display element, based on data acquired from the plant. Also, the display element and the function of the calculation unit 34 will be described later.

Next, the operation according to the screen display in the operating and monitoring station 3 will be described.

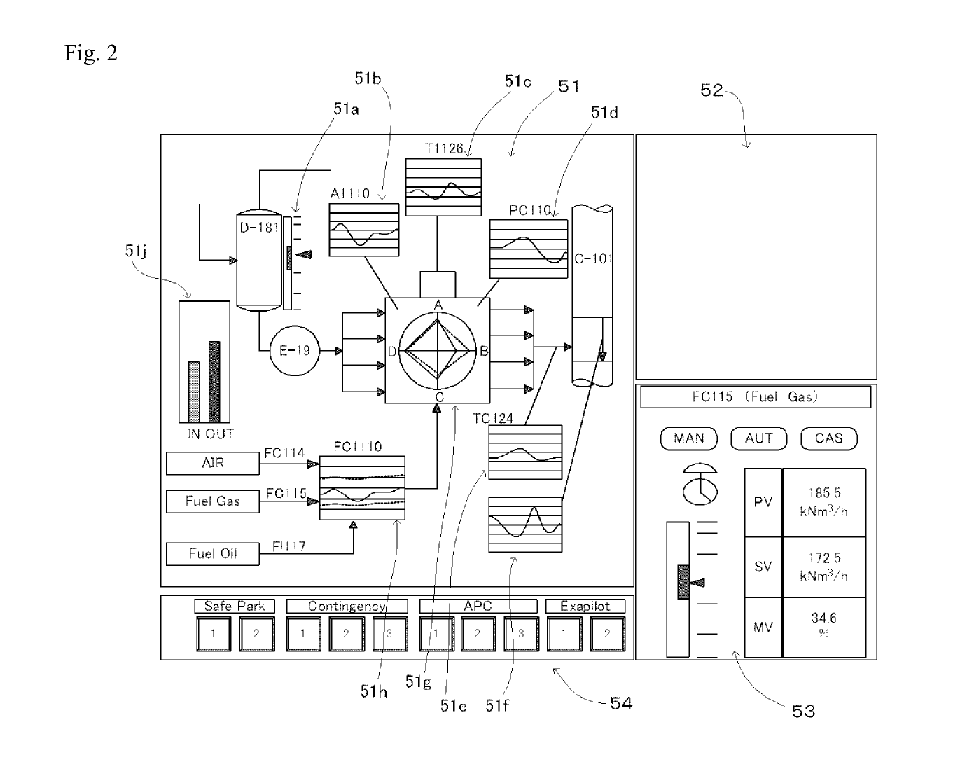

FIG. 2 is a diagram illustrating a display example of the display screen in the monitoring screen 30 of the operating and monitoring station 3.

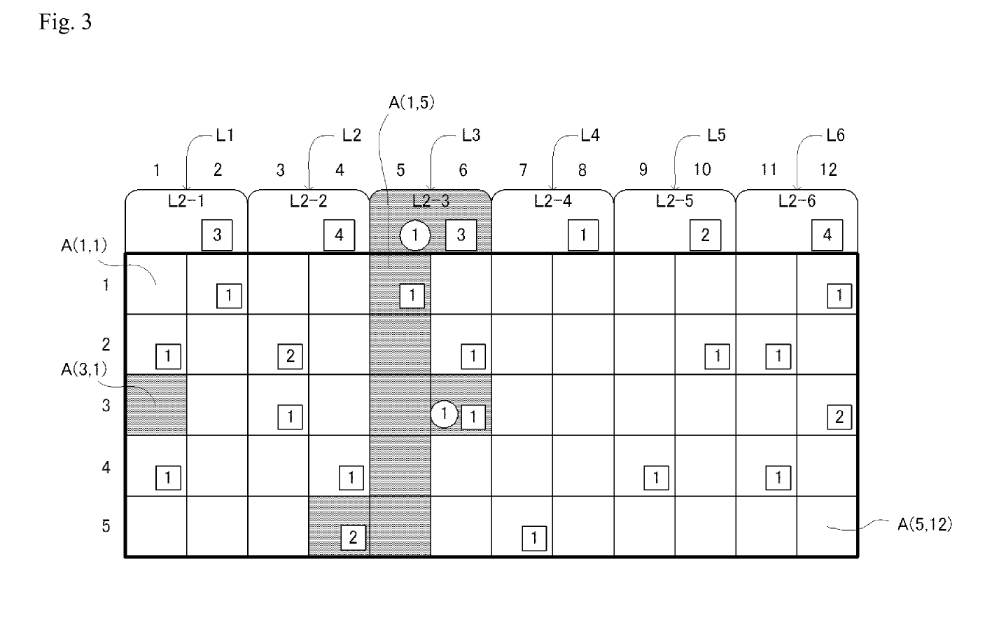

In the example illustrated in FIG. 2, in area 51, a split screen (split display screen) is displayed by the display unit 33. In area 52, a map (FIG. 3) is displayed by the display unit 33. In area 53, an operator screen is displayed to receive a change of a setting value such as a process value and the like. In area 54, a group of emergency buttons to be operated in case of emergency are displayed. Also, the split screen corresponds to a display screen based on operation unit (normal operation screen). The map (FIG. 3) corresponds to a overview screen which covers an entire process.

As illustrated in FIG. 2, display element 51a, display element 51b, display element 51c, display element 51d, display element 51e, display element 51f, display element 51g, display element 51h, and display element 51j are displayed on the split screen of the area 51. These display elements are obtained based on data acquired from the plant by the calculation unit 34.

The respective display elements are analog display elements associated with information useful for the plant operating and monitoring, such as graphs or various patterns which are easy for a human to recognize.

For example, the display element 51g illustrated in FIG. 2 represents four outlet temperatures and four flow rates at four pathes of the furnace in the form of a radar chart. In this example, distortion from a square in the shapes of two radar charts becomes one information chunk. This assists the recognition of the operator. According to the radar chart, the operator can immediately recognize imbalance in a temperature or a flow rate at four pathes. In contrast, on the monitoring screen of the conventional apparatus, the respective outlet temperatures and flow rates are simply displayed one by one in digital form. Therefore, in the past, a difference from a temperature (outlet temperature) of other path, or a difference from a flow rate of other path has been obtained only by a manual calculation. That is, in the conventional apparatus, it is difficult to recognize the event, which can be immediately recognized in the case of the radar chart, unless such complicated tasks are performed.

Also, the display element 51b, the display element 51c, the display element 51d, the display element 51e, the display element 51f, and the display element 51h are trend graphs of numerical values such as process data. As for the operator, for example, a time-series change of a process value is more important information than an instantaneous value of a process value, which is displayed in the conventional apparatus. The conventional apparatus is configured to display the trend graph by an expanding operation from a normal operating screen. Therefore, in the conventional apparatus, two steps are required to confirmed the trend. In contrast, in the present embodiment, a desired trend graph is displayed on the operating screen. Therefore, the operator can immediately recognize the change of the time-series status. The calculation for displaying the trend graph is performed by the calculation unit 34.

Also, the display element 51a is an analog display of a drum liquid level. A liquid level can also be monitored indirectly by flow balance calculation. For example, the calculation unit 34 calculates an integration value of an inflow rate (instantaneous value) to the drum and an integration value of an outflow rate (instantaneous value) from the drum, and can obtain a difference between the two integration values as the drum liquid level change. Therefore, by displaying the drum liquid level in an analog manner, the operator can instantly recognize a current drum liquid level. In the conventional apparatus, when the drum liquid level is not directly measurable, the operator has made a complex calculation using integration values so as to obtain the drum liquid level.

Also, the display element 51j represents a material balance in the drum. By monitoring this, the operator can check whether abnormal leakage and/or accumulation occur at the drum. As the display element 51j, for example, a bar indicating an inflow rate of material flowing into the drum over a predetermined period of time, and a bar indicating an outflow rate of material from the drum are displayed in parallel. Therefore, the operator can instantly check a state of balance between the material inflow rate and the material outflow rate. The calculation unit 34 performs a complex calculation, including a calculation using a large number of variables and an integration of variables. Therefore, the calculation unit 34 can replace cumbersome calculation and thus, the load of the operator is reduced. The same display element may also be used to indicate a heat balance.

In this manner, the number of tags related to the group of display elements displayed on the split screen may be several tens. In the example of FIG. 2, the number of the display elements displayed on the split screen is reduced to nine. Therefore, the operator can focus the operation to the important information, which is acquired in relation to a large number of tags into the display element. The limitation to the number of the display elements in the split screen can also contribute the focused operation of a unit (process unit).

FIG. 3 is a diagram illustrating an example of the map displayed by the display unit 33 (FIG. 1).

As illustrated in FIG. 3, in the map displayed in the area 52, the entire plant is divided into sixty sections, based on the process flow. The respective sections are associated with rectangular display areas A(n, m) arranged in a 5×12 matrix form. In the display areas A(n, m), n represents a position (coordinate) in a vertical direction, and m represents a position (coordinate) in a horizontal direction. The positions of the display areas A(n, m) are defined based on the process flow. The adjacent sections on the process flow are assigned to the adjacent display areas A(n, m).

Also, in the upper side of the map, labels L1 to L6 for selecting the split screen displayed in the area 51 are disposed. The respective labels are previously associated with different split screens. FIG. 3 illustrates an example in which the label L3 associated with the split screen “L2-3” is selected by the operation on the display screen 30. In the area 51, the split screen “L2-3” is displayed. A label selection operation may be received through the receipt unit 32. The display unit 33 displays the selected label L3 with a predetermined color. In this manner, the selection of the label L3 is represented. Also, in the area 51, the split screen “L2-3” associated with the label L3 is displayed by the display unit 33 (FIG. 1).

When the label is selected, the display unit 33 obtains the corresponding split screen from the storage unit 31 (FIG. 1) and displays the split screen in the area 51. Also, the display area corresponding to the section displayed on the split screen associated with the selected label is displayed with a predetermined color by the display unit 33. In this manner, the range displayed on the split screen is represented on the map. For example, in the example of FIG. 3, sections corresponding to a display area A(1, 5), a display area A(2, 5), a display area A(3, 1), a display area A(3, 5), a display area A(3, 6), a display area A(4, 5), a display area A(5, 4), and a display area A(5, 5) are displayed on the split screens of the area 51.

Information which associates the labels L1 to L6, the sections of the plant, and image data of the split screens with one another is stored as display information in the storage unit 31. The display information is appropriately read out by the display unit 33 according to the operation on the receipt unit 32. In this manner, the screen associated with the display information is displayed.

Also, in the respective display areas A(n, m) on the map, alarm activation conditions in the corresponding sections are displayed. The number of mid-priority alarm activations is represented by figures enclosed by circles. The number of low-priority alarm activations is represented by figures enclosed by rectangles. For example, in the example of FIG. 3, in the section of the display area A(3, 6), one mid-priority alarm and one low-priority alarm are respectively activated. In the section of the display area A(1, 5), one low-priority alarm is activated.

Also, in the respective labels L1 to L7, the total number of alarms activated in the sections associated with the respective split screens is displayed. The number of mid-priority alarm activations is represented, for example, by figures enclosed by circles. The number of low-priority alarm activations is represented, for example, by figures enclosed by rectangles. For example, in the example of FIG. 3, in the sections of the split screen “L2-3” associated with the label L3, one mid-priority alarm and three low-priority alarms are activated. Likewise, for example, in the sections of the split screen “L2-4” associated with the label L4, one low-priority alarm is activated.

Such alarm information is acquired from the plant in real time and is reflected to the screen display.

Also, detailed screens for the respective sections associated with the respective display areas A(n, m) on the map are provided. When the display area A (n, m) is clicked, the display unit 33 displays the detailed screen of the corresponding section on the display screen 30. The detailed screen corresponds to the detailed setting screen (level-3 display screen). The information about the correspondence relation between the display area A(n, m) and the detailed screen in each section is stored in the storage unit 31. The display unit 33 reads out such information and reflects the read information to the screen display.

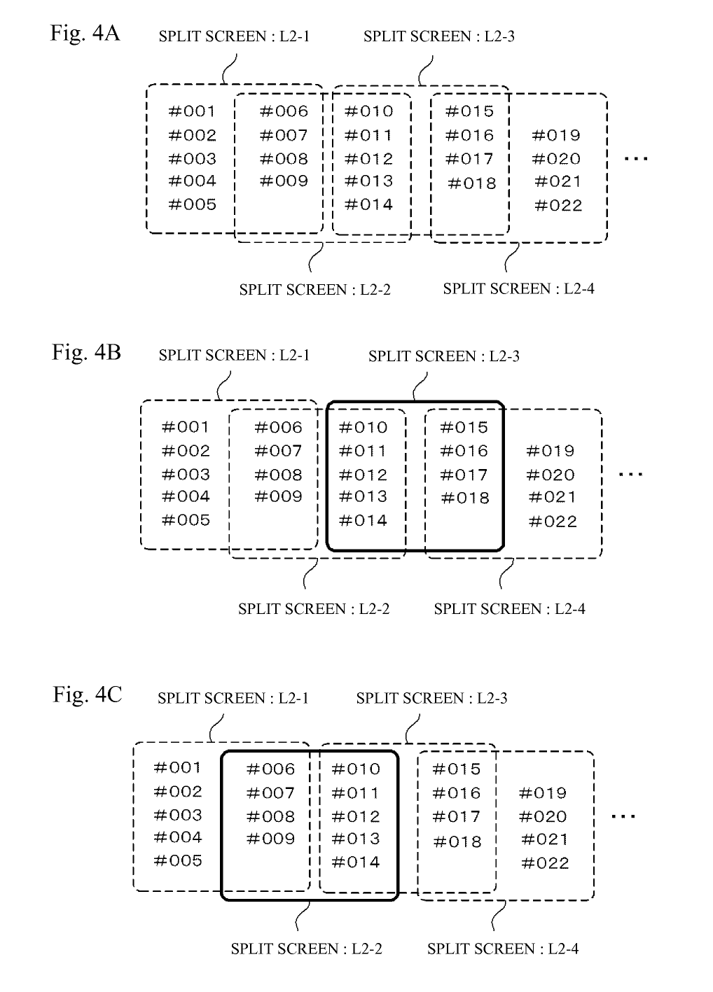

FIGS. 4A to 4C are diagrams illustrating the correspondence relation between the split screen and the display element.

The correspondence relation between the split screen and the display element is defined by the display information stored in the storage unit 31 (FIG. 1).

As illustrated in FIG. 4A, the display elements displayed on the split screens are associated with the respective split screens. “#001”, “#002”, . . . in FIG. 4A represent the respective display elements. Frames surrounding the display elements represent the respective split screens. The display elements included in the respective frames represent the display elements which are displayed on the split screens corresponding to the respective frames.

For example, as illustrated in FIG. 4B, when the split screen “L2-3” is selected, nine display elements indicated by #010 to #018 are displayed on the split screen. Also, as illustrated in FIG. 4C, when the split screen “L2-2” is selected, nine display elements indicated by #006 to #014 are displayed on the split screen.

In the present embodiment, each split screen is associated with five to nine display elements. The number of the display elements is limited based on the viewpoint of cognitive engineering. By limiting the number of the display elements displayed on the respective split screens to below a predetermined number, it is possible to avoid an operator's confusion and a dilution of an operator's consciousness due to excessive information. Therefore, the operator can concentrate on the execution of given tasks.

Also, the plurality of split screens may share the display elements. For example, the split screen “L2-3” illustrated in FIG. 4B and the split screen “L2-2” illustrated in FIG. 4C share five display elements indicated by #010 to #014.

As described above, in the present embodiment, an amount of information displayed on the split screen is limited to five to nine information chunks (display elements). Therefore, it is possible to avoid the operator's confusion and the dilution of the operator's consciousness due to excessive information. Hence, the operator can concentrate on the execution of given tasks. Also, information is represented by analog display such as graphs or various patterns which are easy for a human to recognize. Therefore, the mental stress of the operator can be reduced. In addition, information such as a result of complex calculation is displayed as one information chunk (display element). Therefore, cumbersome operations such as an operation of checking a condition by opening several screens can be significantly reduced.

In the present disclosure, the type of the display element is not limited to the example given in the embodiment. The display element may be, for example, a graph or pattern which represents a trend, a distribution, and a balance of a process variable such as temperature and pressure. In addition, the display element may be a graph or pattern which represents a multidimensional space based on various variables, such as a process variable such as temperature and pressure, a material variable such as property, and a state variable of a device. In particular, since a plurality of numerical values are represented by the multidimensional space, more integrated information can be displayed.

The present disclosure can be widely applied to treating processes related to petroleum, chemicals, or the like, a continuous process or complex process of food, paper and pulp, drug, water treatment, electricity, gas, or the like, and a production process for manufacturing a product through multiple procedures.

The scope of application of the present disclosure is not limited to the embodiment. The present disclosure can be widely applied to an operating and monitoring apparatus and an operating and monitoring method, which monitors operating condition of a plant through a monitoring screen.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An operating and monitoring apparatus for monitoring an operating condition of a plant through a monitoring screen, said apparatus comprising:
a storage unit configured to store a plurality of display screens to be displayed on the monitoring screen;
a receipt unit configured to receive an operation of selecting one display screen among the plurality of display screens stored in the storage unit; and
a display unit configured to display the display screen, selected through the receipt unit, on the monitoring screen,
wherein the plurality of display screens stored in the storage unit includes five to nine display elements, and
the display elements are graphs or patterns associated with numerical values based on data acquired from the plant.

2. The operating and monitoring apparatus according to claim 1, wherein the display screen is a split display screen configured to display a part of the plant.

3. The operating and monitoring apparatus according to claim 1, further comprising:
a calculation unit configured to calculate the numerical values based on the data acquired from the plant,
wherein the calculation result of the calculation unit is sent to the display element and displayed on the display screen.

4. The operating and monitoring apparatus according to claim 2, further comprising:
a calculation unit configured to calculate the numerical values based on the data acquired from the plant,
wherein the calculation result of the calculation unit is sent to the display element and displayed on the display screen.

5. The operating and monitoring apparatus according to claim 1, wherein the display unit displays a map in which the display element is associated with a display area, and represents the display area, which is associated with the display element included in the display screen displayed on the monitoring screen, on the map.

6. The operating and monitoring apparatus according to claim 2, wherein the display unit displays a map in which the display element is associated with a display area, and represents the display area, which is associated with the display element included in the display screen displayed on the monitoring screen, on the map.

7. The operating and monitoring apparatus according to claim 3, wherein the display unit displays a map in which the display element is associated with a display area, and represents the display area, which is associated with the display element included in the display screen displayed on the monitoring screen, on the map.

8. The operating and monitoring apparatus according to claim 4, wherein the display unit displays a map in which the display element is associated with a display area, and represents the display area, which is associated with the display element included in the display screen displayed on the monitoring screen, on the map.

9. An operating and monitoring method for monitoring operating condition of a plant through a monitoring screen, said method comprising the following steps:
a storing step of storing a plurality of display screens to be displayed on the monitoring screen;
a receiving step of receiving an operation of selecting one display screen among the display screens stored in the storing step; and
a displaying step of displaying the display screen, selected through the receiving step, on the monitoring screen,
wherein the display screens stored in the storing step includes five to nine display elements, and
the display elements are graphs or patterns associated with numerical values based on data acquired from the plant.

10. The operating and monitoring method according to claim 9, wherein the display screen is a split display screen configured to display a part of the plant.
